(19) United States
(12) Patent Application Publication
(10) Pub. No.: US 2003/0053613 A1
(43) Pub. Date: Mar. 20, 2003

(54) Method for call processing in a telecommunications network and associated units

(76) Inventor: Rik Van den Berghe, Gistel (BE)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/206,988

(22) Filed: Jul. 30, 2002

(30) Foreign Application Priority Data
Jul. 30, 2001 (DE) 01118282.1

(51) Int. Cl. H04M 3/42

(52) U.S. Cl. 379/207.02; 379/207.04; 379/211.02

(57) ABSTRACT

A system and method in which, for a terminal device of a subscriber, a simulation operating mode which differs from the normal operating mode of the terminal device is selected. In the simulation operating mode, a use of the terminal device is simulated by the called subscriber with the aid of an automatic selection function.

### CLAIM FOR PRIORITY

This application claims priority of European application 01118282.1 filed Jul. 30, 2001.

### TECHNICAL FIELD OF THE INVENTION

The invention relates to a method in which calls arriving on a subscriber connection in a normal operating mode are processed depending on the busy/idle status of the subscriber connection.

### BACKGROUND OF THE INVENTION

The telecommunications network is, for example, a switched telecommunications network, in which voice channels are switched for the duration of a connection. An example of a telecommunications network of this type is the Deutsche Telekom AG telecommunications network. A different example of a telecommunications network is a packet-transmitting network, for example, the Internet. Standardized methods are used for real-time voice transmission, e.g. the VoIP (Voice over Internet Protocol) method. However, networks are also used in which the voice data are switched in segments and are transmitted in data packets in other segments.

The fact that incoming calls remain unanswered for a specific period of time allows inferences to be made as to whether a subscriber is present at or absent from his place of residence. If only a ringing tone is audible to the calling subscriber when a subscriber connection is called over a lengthy period, for example several days or weeks, it can be assumed that the called subscriber is absent. This runs the risk that the absence of a subscriber can be established by other subscribers via the telecommunications network.

### SUMMARY OF THE INVENTION

The invention relates to a system and method in which calls arriving on a subscriber connection in a normal operating mode are processed depending on the busy/idle status of the subscriber connection. If, for example, a terminal device operated on an analog subscriber connection is already busy, further call set-up to this terminal device is not possible. If the terminal device is free, further call processing depends on the settings on the terminal device. For example, the generation of ringing tones in the direction of the calling subscriber and the generation of a ringing signal are initiated by the terminal device. A telephone answering machine can also be activated. Other switching response options entail automatic call diversion to a different terminal device of the telecommunications network, e.g. to an automatic voice-recording unit or to a different terminal device of the called subscriber, or of a different subscriber.

The invention discloses a system and method for call processing which guarantees that the non-use of the subscriber connection and the absence of a subscriber can no longer be readily established by other subscribers via the telecommunications network. Furthermore, an associated device, an associated switching center, an associated PBX system, an associated terminal device and an associated program are disclosed.

The invention is considers the non-use of a subscriber connection such that the absence of a subscriber cannot be established via the telecommunications network if the presence of the subscriber is simulated by incorporating an automatic selection function. By means of the simulation, switching signals are fed to the calling subscriber which make it difficult to infer the use of the subscriber connection and therefore the absence of the subscriber who wishes to conceal his absence.

In one embodiment of the invention, for the terminal device of the subscriber who wishes to conceal his absence, a simulation operating mode which differs from the normal operating mode of this terminal device is selected. The simulation operating mode can be selected, for example, by actuating a switch, by selecting a specific telephone number, or in a different way.

For the simulation operating mode, a plurality of switching response options are specified for incoming calls, for example the generation of a ringing tone or a busy tone. For incoming calls, the response options are selected according to the automatic selection function, independently of the switching status on the subscriber connection. Use of the terminal device of the called subscriber is simulated for the calling subscriber on the basis of this selection of response options.

Thus, even if a plurality of successive calls are made to the terminal device of the subscriber whose absence is to be concealed, a calling subscriber cannot be sure whether the subscriber is present or absent. Under such circumstances, subscribers with intentions other than the desire to set up a call will tend to concentrate on subscribers whose absence can be more readily determined, i.e. on subscribers who do not use the “simulation operating mode” user facility during their absence.

In another embodiment of the invention, the selection function is defined on the basis of the actual use of the terminal device by the subscriber. The type of use of the terminal devices of different subscribers normally differs. Thus, the selection functions for different subscribers also differ from one another. The use of different selection functions makes it difficult for the calling subscriber to establish whether the simulation operating mode or the normal operating mode is active.

In still another embodiment according to the invention, any two, three, four or five of the following response options are specified, from which the selection function selects:

Generation of a busy tone, which signals to the calling subscriber that the called terminal device is already involved in a telecommunications connection. The busy tone is generated without a connection actually been set up between the called terminal device and a different terminal device. The connection can be set up if the subscriber operates the terminal device. The busy tone is therefore simulated to the calling subscriber.

Generation of a ringing tone which signals to the calling subscriber that the called subscriber is being called via a signaling device on the called terminal device, irrespective of whether a signal tone is generated on the terminal device of the called subscriber. The signaling device is preferably a loudspeaker, which emits a ringing tone. In one design, the ringing tone is generated without the signaling device being activated. Alternatively, however, the signaling device may actually also be activated. The generation of a signal with the signaling device is preferably toll-free.

Diversion of the incoming call to a different connection or to a voice-recording unit, e.g. to a “voice box”.

Start-up of a telephone answering machine connected to the subscriber connection. The telephone answering machine is started up, for example, after several ringing tones have been generated.

Diversion of the incoming call to a terminal device which is used to provide the simulation operating mode for a plurality of terminal devices of different subscribers. An attendant, for example, is present at the terminal device to which the call is diverted, and greets the caller. The calling subscriber will hang up immediately if he has intentions other than the desire to set up a call. The calling subscriber will refrain from further “investigations” of the subscriber connection in order, for example, to prevent tracing.

In another embodiment according to the invention, there is a method performed in a switching center. A switching center is used for charge-based switching of connections for a multiplicity of subscribers. Examples of switching centers are switching centers of the EWSD type (electronically controlled digital dialing system) from Siemens AG or of the S12 type from Alcatel AG. If the method according to the invention is carried out in a switching center, multiple use of programs or program components and hardware components is enabled in order to provide the simulation operating mode for different subscribers. The simulation operating mode user facility can thereby be implemented at low cost for a multiplicity of subscriber connections. The subscribers can continue to use their previously used terminal devices, i.e. they do not require new terminal devices.

In still another embodiment of the invention, there is a method performed in a PBX system. Telecommunications systems are used for toll-free switching of connections between terminal devices which are normally connected within the private premises of the PBX system operator. The advantages specified for the switching center similarly apply to the PBX system.

In yet another embodiment of the invention, the method is performed in the terminal device of a subscriber. Through this measure, conventional switching centers and PBX systems can be used without modifications. Nevertheless, subscribers can make use of the advantages of the method according to the invention.

In another embodiment according to the invention, the selection function selects the response options according to a random sequence. For example, a random function is used which includes a noise generator to generate white noise. However, there are also random functions which determine a random number in a different manner, for example depending on a system time. The random number can then be used to select a response option. In contrast to deterministic functions, random functions cannot be described by a unique relationship between an input variable and an output variable.

In still another embodiment of the invention, there is a device for operating a subscriber connection, in particular a switching center, a PBX system or a terminal device, during the operation of which the method according to the invention or one of its further embodiments is carried out. The aforementioned features therefore also apply to these units. A unit includes a memory device to store the response options. Furthermore, a unit includes a control unit which selects the response options for the incoming calls according to an automatic selection function. Use of the terminal device is again simulated by the called subscriber through the incorporation of the selection function.

Another embodiment of a unit includes an operating mode memory device, in which the operating mode is stored, i.e. the normal operating mode or the simulation operating mode. The control unit processes the incoming calls depending on the stored operating mode. Switchover from one operating mode to the other operating mode can thus be simply carried out. In particular, the same unit can be used to perform the functions in both operating modes.

The invention also relates to a program or a memory unit with a program. The program includes a command string, during the execution of which the method according to the invention or one of its further embodiments is carried out by means of a processor. The aforementioned technical effects therefore also apply to the program or the memory unit.

### BRIEF DESCRIPTION OF THE DRAWINGS

Embodiments of the invention are explained below with reference to the attached drawings, in which:

FIG. 1 shows a telecommunications network with a simulation function, which is included in a switching center.

FIG. 2 shows a method for simulating the presence of a subscriber using the simulation function.

FIG. 3 shows a terminal device with a simulation function.

### DETAILED DESCRIPTION OF THE PREFERRED EMBODIMENTS

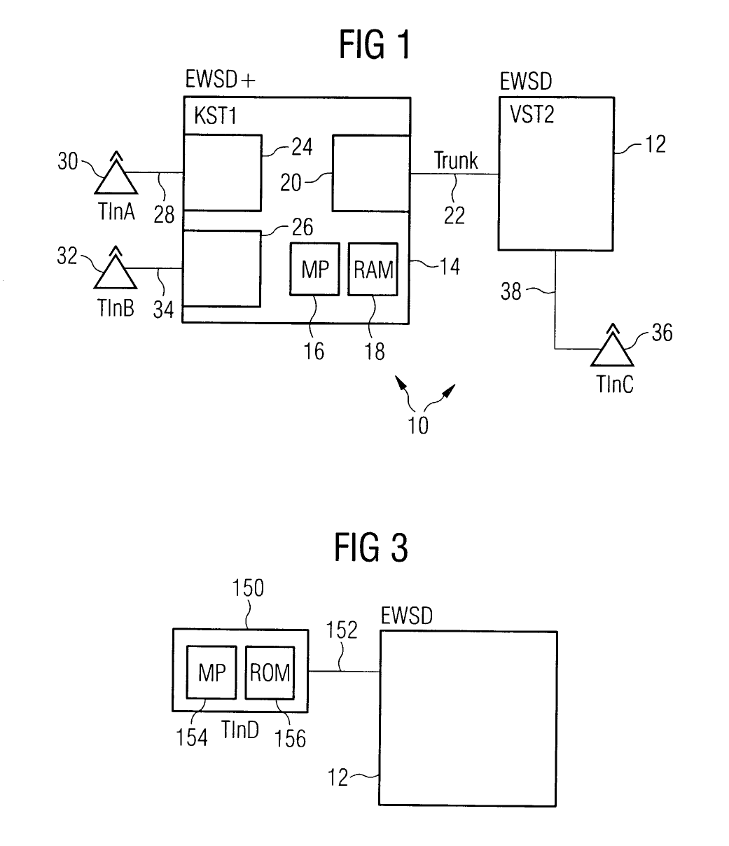

FIG. 1 shows a telecommunications network 10, e.g. the Deutsche Telekom AG telecommunications network. FIG. 1 shows two switching centers 12, 14 of the EWSD type (electronically controlled digital dialing system) from Siemens AG. The switching center 12 is a conventional switching center. The switching center 14 has been expandeded to include a simulation function which prevents the absence of a subscriber TlnA from being determined by other subscribers TlnB and TlnC via the telecommunications network 10. This simulation function is explained in detail below.

Apart from the additional simulation function, the switching centers 12 and 14 are identically structured, so that the structure of the switching center 14 is explained below. The switching center 14 includes a central processor 16, with the aid of which central control tasks are performed. Commands of a control program are stored in a main memory 18. The commands are executed by the processor 16. The main memory 18 is, for example, a volatile memory, e.g. a RAM (Random Access Memory). A connection unit 20 of the switching center 14 serves to connect connecting lines which lead to other switching centers, see e.g. the connection line 22 between the switching centers 12 and 14. The connection line 22 is also referred to as a trunk.

In order to connect subscriber lines, the switching center 14 includes a plurality of subscriber connection modules, of which two subscriber connection modules 24 and 26 are shown in FIG. 1. ISDN (Integrated Services Digital Network) subscribers, for example, are connected to the connection modules 24, see e.g. the connection line 28 leading to the subscriber TlnA. The subscriber TlnA has a terminal device 30, which is connected to the subscriber connection line 28. The terminal device 30 is, for example, a conventional ISDN telephone.

The connection module 26 serves to connect subscribers using analog terminal devices. Thus, the subscriber TlnB users an analog telephone 32, which is connected via a subscriber connection line 34 to the connection module 26.

The switching center 14 furthermore includes additional structural units (not shown). In particular, the switching center 14 includes a switching network to set up voice connections and to exchange signaling messages between the connection modules 24, 26 and the connection unit 20.

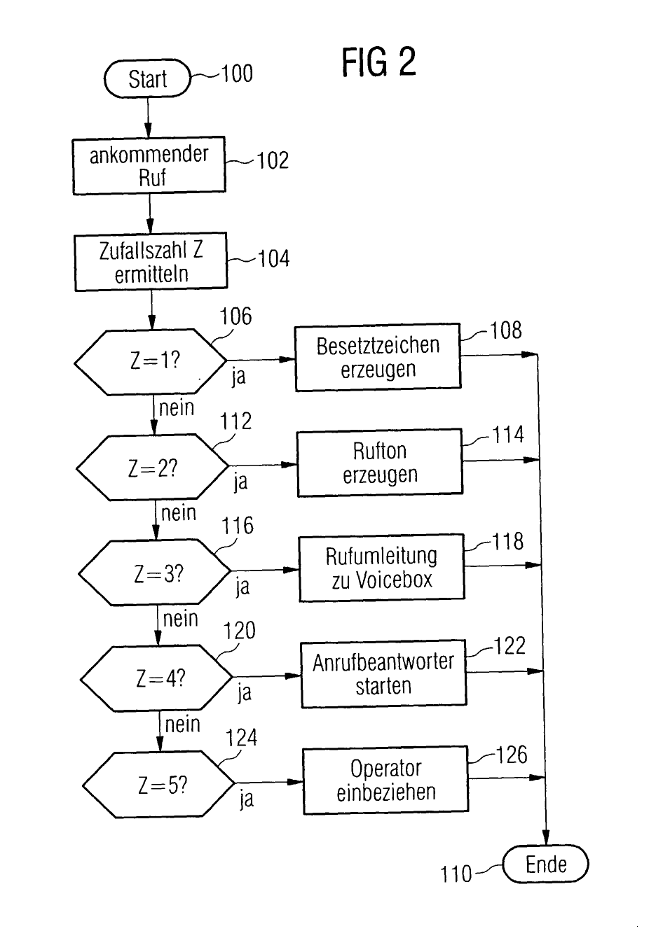

The subscriber TlnC uses a terminal device 36, which is connected via a subscriber connection line 38 to the switching center 12. To explain the embodiment, it is assumed that the subscriber TlnA is away from home for four weeks and has requested the “simulation operating mode” user facility from the network operator of the telecommunications network 10. In response, the network operator has activated the simulation operating mode on the subscriber connection of the subscriber TlnA for the time during which the subscriber TlnA is away from home. The “simulation operating mode” function is performed by the switching center 14. The method carried out are explained in detail below with reference to FIG. 2.

It is assumed that the trade of the subscriber TlnC involves ascertaining which subscribers Tln are absent for a lengthy period. To do this, a user successively dials the telephone numbers of a telephone number list several times and records whether the call is answered. The telephone number list is, for example, a page of a telephone directory, on which the telephone number of the subscriber TlnA is also listed. As soon as an incoming call from the subscriber TlnC intended for the subscriber connection of the subscriber TlnA arrives at the switching center 14, the method explained below with reference to FIG. 2 are carried out in order to simulate the presence of the subscriber TlnA to the subscriber TlnC during the simulation operating mode.

FIG. 2 shows a method for simulating the presence of the subscriber TlnA using a random function. The method begins in at the method in 100. In the method of 102 following the method in 100, a call from the subscriber TlnC arrives in the exchange 14. The control unit of the switching center 14 including the processor 16 recognizes from the destination telephone number that a connection is to be set up to the terminal device 30 of the subscriber TlnA. The switching center 14 ascertains, by means of a stored marker for the destination telephone number, that the simulation operating mode is activated for the subscriber TlnA. The incoming call in 102 is therefore not through-connected as usual to the terminal device 30, but instead the method in 102 is followed by the method in 104.

In the method of 104, a random number in the 1-5 range is determined with the aid of a random function. The random number here is an integer. The system time of a system clock included in the switching center 14, for example, is used to determine the random number Z.

The method in 104 is followed by the method in 106 which checks whether the random number Z determined in the method in 104 has the value one. If the random number Z has the value one, the method in 106 is followed by the method in 108. In the method in 108, the control unit of the switching center 14 including the processor 16 causes a busy signal to be generated in the direction of the subscriber TlnC, even though the terminal device 30 is not actually busy. After the method in 108, the method ends in the method in 110, until the next call arrives.

However, if it is ascertained in the method in 106 that the random number Z does not have the value one, the method in 106 is followed by the method in 112. In the method in 112, a check is carried out to ascertain whether the random number Z has the value two. If the random number Z has the value two, the method in 112 is followed by a method in 114. In the method in 114, the switching center 14 causes a ringing tone to be generated in the direction of the subscriber TlnC. However, no signaling messages are sent to the terminal device 30. After the method in 114, the method again ends in the method in 110 until the next call arrives on the subscriber connection of the subscriber TlnA, for example, in that the subscriber TlnC hangs up.

If, however, it is established in the method in 112 that the random number does not have the value two, the method in 112 is followed by a method in 116. In the method in 116, a check is carried out to ascertain whether the random number Z has the value three. If so, the method in 116 is followed by a method in 118. In the method in 118, the call arriving from the subscriber TlnC is diverted to a “voicebox” of the subscriber TlnA which is included in the switching center 14 and which occupies a memory area in a memory unit (not shown). After the method in 118, the method ends in the method in 110, for example, in that the subscriber TlnC hangs up.

If, however, it is established in the method in 116 that the random number Z does not have the value three, the method in 116 is followed by a method in 120. In the method in 120, a check is carried out to ascertain whether the random number Z has the value four. If so, the method in 120 is followed by a method in 122. In the method in 122, a telephone answering machine located in the terminal device 30 is started up. The subscriber TlnC then has the option of speaking a message into this telephone answering machine. The method then ends in the method in 110.

If, however, it is established in the method in 120 that the random number Z does not have the value four, the method in 120 is followed by a method in 124. In the method in 124, a check is carried out to ascertain whether the random number Z has the value five. If the random number Z has the value five, the method in 124 is followed by a method in 126. In the method in 126, a connection is set up for the call arriving from the subscriber TlnC to the terminal device of an attendant employed by the operator of the telecommunications network 10. The attendant answers with a noncommittal greeting. After the method in 126, the method ends in the method in 110, for example, in that the subscriber TlnC hangs up.

If the subscriber TlnC tries to call the subscriber TlnA again after several hours or days, the method is again carried out. Due to the use of the random number Z, one of the response options 108, 114, 118, 122 or 126 is selected in a random and therefore unpredictable manner. It is therefore very difficult for the subscriber TlnC to establish whether the subscriber TlnA is present or whether his presence is merely being simulated by the simulation operating mode.

The flow chart shown in FIG. 2 is one implementation option for the sequence of the various methods. Thus, in a different embodiment, a single branch instead of the branches 106, 112, 116, 120 and 124 is used. The query in the method in 124 is also omitted in a further embodiment.

FIG. 3 shows a terminal device 150 of a subscriber TlnD. The terminal device 150 is connected via a subscriber connection line 152 to the conventional switching center 12. However, the terminal device 150 has a structure which guarantees that the methods explained with reference to FIG. 2 can be carried out by the terminal device 150. Thus, the terminal device 150 includes a microprocessor 154 and a non-volatile memory unit 156, e.g. a ROM (Read-Only Memory). Two operating modes can be selected on the terminal device 150, i.e. a “normal operating mode”, and a “simulation operating mode”. If the subscriber TlnD is not at home for a lengthy period, he activates the “simulation operating mode”. Calls arriving on the terminal device 150 are thus processed according to the method explained with reference to FIG. 2.

In another embodiment, mobile terminal devices, which are linked via radio transmission paths to the switching center 12 or 14, are used instead of the line-connected terminal devices 30, 32, 36 and 150.

What is claimed is:

1. A method for call processing in a telecommunications network, comprising:
selecting, for a subscriber connection of a subscriber, a simulation operating mode which differs from the normal operating mode of the subscriber connection;
predefining a plurality of switching response options for the simulation operating mode for incoming calls;
selecting, in the event of an incoming call, one of the response options according to an automatic selection function; and
simulating a use of the subscriber connection by the subscriber on the basis of the incorporation of the selection function.

2. The method as claimed in claim 1, wherein the selection function is determined by the subscriber on the basis of the actual use of the terminal device, and the selection functions differ from one another for different subscribers.

3. The method as claimed in claim 1, wherein at least one of the switching response options
generates a busy tone which signals to the calling subscriber that a terminal device connected to the subscriber connection is using a telecommunications connection;
generates a ringing tone which indicates to the calling subscriber that the called subscriber is being called via a signaling device;
diverts the incoming call to a different subscriber connection or to a voice-recording unit;
starts a telephone answering machine connected to the subscriber connection; and/or
diverts the incoming call to a terminal device which is used to provide the simulation operating mode for a plurality of subscriber connections.

4. The method as claimed in claim 1, wherein the method is carried out in a switching center, in a PBX system or in the terminal device of the subscriber.

5. The method as claimed in claim 3, wherein the selection function selects the response options according to a random sequence.

6. A device for call processing, comprising:
a response option memory device to store a plurality of switching response options in the event of incoming calls on a subscriber connection of a subscriber; and
a control unit which, for the incoming calls, selects one of the response options according to an automatic selection function, wherein the control unit simulates a use of the terminal device by the called subscriber on the basis of the incorporation of the selection function.

7. The device as claimed in claim 6, further comprises an operating mode memory device to store a simulation operating mode which differs from the normal operating mode of the subscriber connection, wherein the control unit processes incoming calls depending on the stored operating mode.

8. A computer readable medium with a program stored thereon, the program performing:
selecting, for a subscriber connection of a subscriber, a simulation operating mode which differs from the normal operating mode of the subscriber connection;
predefining a plurality of switching response options for the simulation operating mode for incoming calls;
selecting, in the event of an incoming call, one of the response options according to an automatic selection function; and
simulating a use of the subscriber connection by the subscriber on the basis of the incorporation of the selection function.
